(19) United States
(12) Patent Application Publication
(10) Pub. No.: US 2008/0167894 A1
(43) Pub. Date: Jul. 10, 2008

(54) ASSISTING A SELLER IN A SALE OF PROPERTY

(75) Inventors: John Capozzi, Fairfield, CT (US); Anthony Holdamf, Fairfield, CT (US); Jerry O'Rourk, New Canaan, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Private Sale Partners, Inc., Westport, CT (US)

(21) Appl. No.: 11/972,461

(22) Filed: Jan. 10, 2008

Related U.S. Application Data
(60) Provisional application No. 60/879,621, filed on Jan. 10, 2007.

(51) Int. Cl. G06Q 30/00

(52) U.S. Cl. 705/1

(57) ABSTRACT

There is provided a method, performed by a service provider, that includes (a) providing a service to a seller for a fee, to assist the seller in a sale of a property without an agent to represent the seller, and (b) refunding the fee, if the seller lists the property with an agent suggested by the service provider.

### BACKGROUND OF THE DISCLOSURE

1. Field of the Disclosure

The present disclosure relates to a service to assist a seller of property, and more particularly, to assist the seller in the sale of the property without an agent to represent said seller. The service is particularly well-suited for a situation where the property is a parcel of real estate.

2. Description of the Related Art

Homeowners traditionally sell their homes in one of two ways: via traditional real estate brokers, or by themselves, which is known as “For Sale by Owner” (FSBO). There are several advantages to selling a home without a broker, most notably the savings associated with not having to pay a broker a fee or a commission. The disadvantage of selling without a broker, however, is that the seller gives up the marketing support and advice that a broker may provide. On average, an FSBO home is only listed for about three months before many owners give up and transfer the listing to a broker. This is because potential buyers tend to look upon FSBO homes as a risk. Given that a home purchase is a major expenditure, buyers want the security of an established broker to guide them through the transaction. It can also be extremely difficult for an FSBO owner to keep track of incoming leads and schedule appointments to show the home.

The trend with traditional real estate brokers is slightly different. Most homeowners list their home with a broker for a contract period of six months to one year. If the home has not sold during the contract period, many sellers become frustrated, switch to another broker, and re-list the home, hoping that the new broker will have a wider selection of customers to purchase the home. In any case, however, one advantage of using a broker, aside from having a professional to guide the homeowner through the transaction, is that brokers advertise and hopefully produce leads.

### SUMMARY OF THE DISCLOSURE

There is provided a method, performed by a service provider, that includes (a) providing a service to a seller for a fee, to assist the seller in a sale of a property without an agent to represent the seller, and (b) refunding the fee, if the seller lists the property with an agent suggested by the service provider.

### BRIEF DESCRIPTION OF THE DRAWINGS

FIG. 1 is a process flow diagram of a method in which a service provider assists a seller in a sale of property, showing how the seller interacts with the method.

FIG. 2 is a process flow diagram of a method in which a service provider assists a seller in a sale of property, showing how a party that may be a potential buyer interacts with the method.

FIG. 3 is a block diagram of a computer system that employs a method that assists a seller in a sale of property, and includes a scheduler with which a seller and a party can schedule an appointment for the party to visit the property.

### DETAILED DESCRIPTION OF THE DISCLOSURE

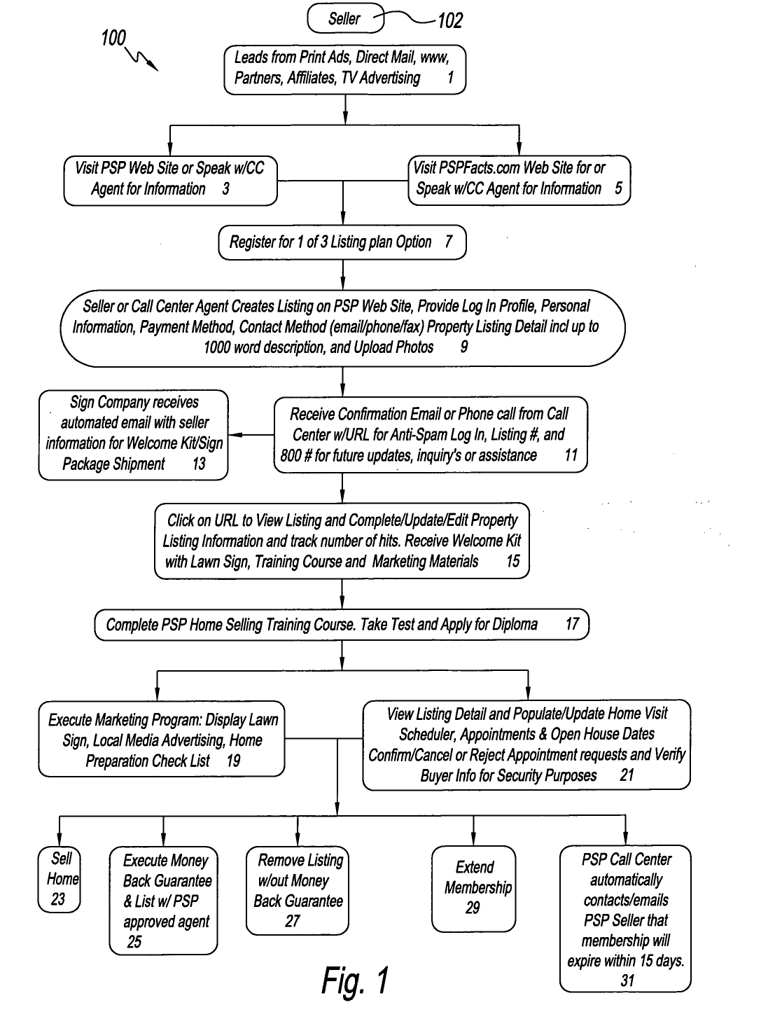

FIG. 1 is a process flow diagram of a method 100 in which a service provider assists a seller 102 in a sale of property, showing how seller 102 interacts with method 100. The service provider is also designated herein as a private sale partner (PSP). In method 100, the service provider provides a service to seller 102 for a fee, to assist seller 102 in a sale of the property without an agent to represent seller 102. However, the service provider refunds the fee if seller 102 lists the property with an agent suggested by the service provider. The refund is not contingent on whether the agent suggested by the service provider consummates a sale of said property. The service provider also provides a toll-free telephone number that a party can call to inquire about the property.

In step 1, the service provider initiates marketing efforts to potential FSBO sellers, for example generating leads from print ads, direct mail, web advertising, partner referrals, television ads. Method 100 proceeds in parallel to steps 3 and 5.

In either of steps 3 and 5, seller 102 visits a website maintained by the service provider, or is offered an opportunity to speak with a call center agent to get more information about seller 102's possible participation in method 100. The information provides plans for listing a property, e.g., a parcel of real estate, that seller 102 wishes to sell. From steps 3 and 5, method 100 proceeds to step 7.

In step 7, seller 102 registers to participate in a plan for listing the property. Such a plan may be, for example, one that is for a limited time, for a fixed fee, or for a combination of limited time and fixed fee. Method 100 next proceeds to step 9.

In step 9, either seller 102 or the service provider creates, on the service provider's website, a listing for the property. Such a listing can include a textual description of, as well as visual media showing, the property. Seller 102 is permitted to make modifications to both textual and visual depictions of the property (see step 15). Method 100 proceeds to step 11.

In step 11, the service provider sends seller 102 a confirmation, via email or phone call, with a uniform resource locator (URL) for an anti-spam log in, a listing number, and a toll-free number, e.g., an 800 number. Also in step 13, the service provider sends an email to a sign company, instructing the sign company to prepare a sign (see step 13). In the email, the service provider includes predetermined information about seller 102 and seller 102's property. From step 11, method 100 progresses to step 15.

In step 13, the sign company receives the email from the service provider, instructing the sign company to prepare a sign. The sign company, in turn, includes the information about seller 102 and seller 102's property on a variety of printed products. The variety of printed products includes a sign, suitable for outdoor display, e.g., a lawn sign, advertising seller 102's property as a property for sale. However, the sign will not reveal seller 102's direct contact information, but rather will present information as to how a party can contact the service provider.

In step 15, seller 102 visits the service provider's website to view seller 102's listing. Seller 102 can update and/or edit information pertinent to the listing of seller 102's property. Seller 102 also indicates in step 15 his readiness to receive a welcome kit and a home-study training course (“training course”) from the service provider, to help seller 102 more easily undertake a FSBO sale. Method 100 next proceeds to step 17.

In step 17, seller 102 completes the home-study training course. Seller 102 upon completion of his studies, will complete a test to assess his mastery of skills taught by the home-study training course, and, if his mastery is sufficient, seller 102 will be allowed to apply for a certificate of completion, i.e., a diploma. The training course can provide valuable information for seller 102 such as: an introduction to the real estate market, how best to utilize the service provider's services such as mortgage program access, appraisal services, insurance services, title insurance services, home warranty options, legal services, relocation services, demographic data on schools/government services, population and crime statistics, what to expect when selling one's own property, how to evaluate and prepare a property for sale, tools and skills to price a property properly, marketing techniques to assist in the generation of business leads, how to develop interest in a property, how to organize and promote an open house, how to qualify a buyer, how to handle offers and counteroffers, how to close a sale, how to prepare for a buyer's inspection tour, information about relevant legal matters, and other generally helpful information. Method 100 next proceeds to steps 19 and 21 in parallel.

In step 19, seller 102 commences active marketing of his property. Seller 102 places his lawn sign on display, advertises the property in a variety of media, and completes a home-preparation checklist, in accordance with the teachings of the training course. Method 100 next proceeds to one of steps 23, 25, 27, 29, or 31.

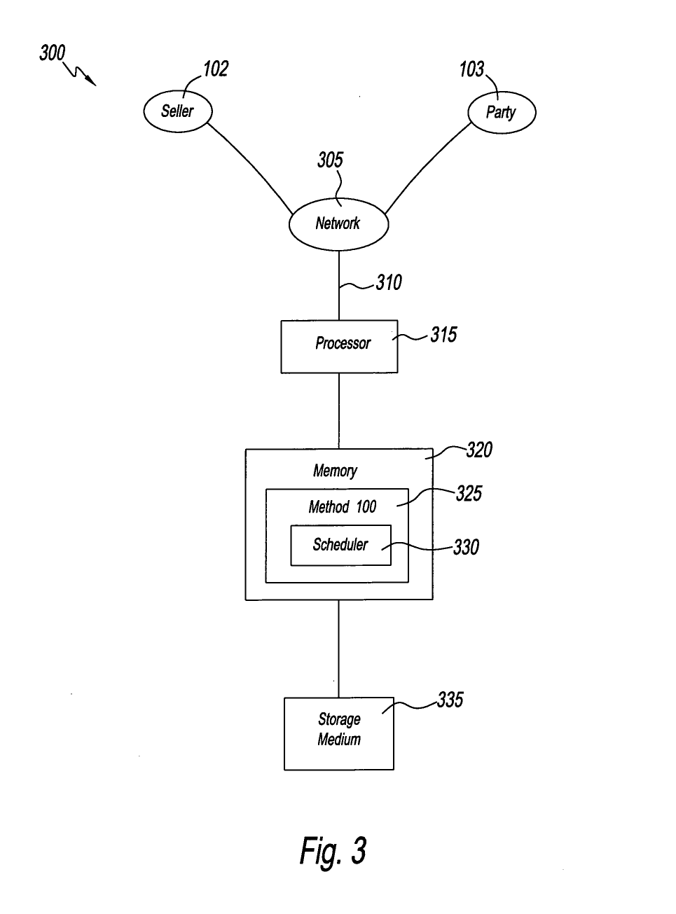

In step 21, seller 102 views on the service provider's website listing of seller 102's property. Seller 102 can track the number of times his listing has been viewed. The website listing of seller 102's property includes a scheduler, with which seller 102 can easily make, unmake, and modify appointments with potential buyers to see the property (see FIG. 3, which shows a scheduler embodied in a program module 330). One possible mechanism for seller 102 to make an appointment with a potential buyer is to accept an appointment request from a potential buyer. Seller 102, in deciding whether to make an appointment with a particular potential buyer, can verify the potential buyer's information/identity for security purposes (see step 36, below). Method 100 next proceeds to one of steps 23, 25, 27, 29, or 31.

Step 23 is reached if seller 102 and a potential buyer reach a satisfactory arrangement with regard to seller 102's property. A sale of the property is consummated, and method 100 then ends.

Steps 25, 27, 29, and 31 are reached if seller 102 is unable to consummate a sale with any potential buyer.

In step 25, seller 102, being unable to consummate a sale of his property, is offered a refund by the service provider of fees paid, if seller 102 opts to re-list the property with a realtor from an approved real estate partner of the service provider. Method 100 is then at an end, and seller 102 proceeds to attempt to sell the property in a conventional realtor-assisted (i.e. non-FSBO) way. The service provider will continue to maintain seller 102's listing on a web page or other form of publication, and will refer interested potential buyers to seller 102's realtor.

In step 27, seller 102, being unable to consummate a sale of his property, or being no longer interested in offering the property for sale, or perhaps being interested in using a completely different sales strategy, instructs the service provider to cease advertising the property. Seller 102 does not receive any refund or further service from the service provider, and method 100 then ends.

In step 29, seller 102, being unable to consummate a sale of his property by the end of a predetermined amount of time, i.e., at the end of a period of subscription to the services of the service provider, may opt to renew. If seller 102 renews, then seller 102 can continue attempting to schedule visits with prospective buyers as described above.

In step 31, the service provider automatically contacts seller 102 at a predetermined time before seller 102's listing plan with the service provider is to expire. The service provider extends to seller 102 an offer to renew seller 102's listing plan. If seller 102 opts not to renew, then at the end of a predetermined time period seller 102's listing plan will be inactivated. If seller 102 renews, then seller 102 can continue attempting to schedule visits with prospective buyers as described above.

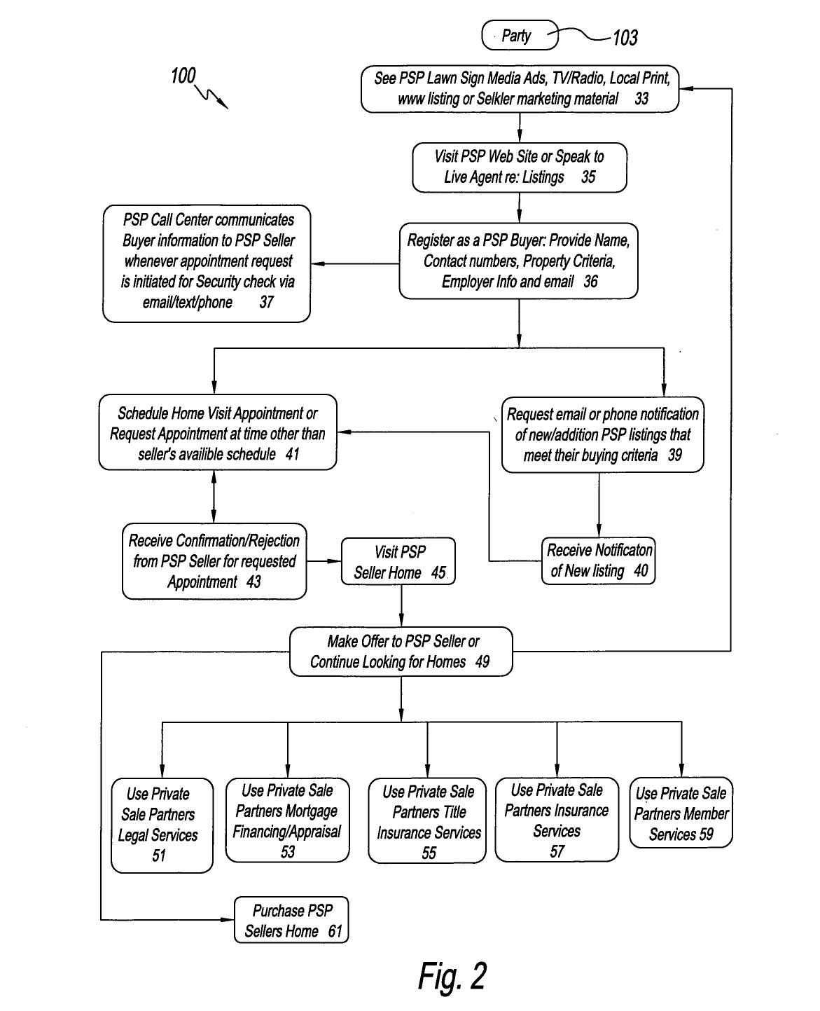

FIG. 2 is a process flow diagram showing how a party 103, that may be a potential buyer, interacts with method 100.

In step 33, party 103 becomes aware of the property being sold by seller 102. Party 103 may have, for example, seen seller 102's lawn sign, or may have seen seller 102's listing on the service provider's website. If party 103 is interested in the property, then method 100 proceeds to step 35.

In step 35, party 103 uses contact information presented on seller 102's lawn sign, the service provider's website, or some other advertising medium, to establish communication with the service provider. Party 103 can communicate with the service provider through, for example, the service provider's website, or by calling a call center maintained by the service provider. When party 103 has established communication with the service provider, method 100 proceeds to step 36.

In step 36, party 103 registers with the service provider. Party 103 completes a security questionnaire either online or via a toll-free phone call in order to proceed to further steps of method 100 (detailed below). The service provider requests information from party 103, such as, an identification of party 103, contact information for party 103, identification of an employer of party 103, and contact information of an employer of party 103. Having received this information from party 103, the service provider performs a screening of party 103 on behalf of seller 102, to determine whether party 103 is a potential buyer of the property. One reason for screening party 103 is to weed out real estate agents from the pool of would-be buyers. If party 103 does not provide the requested information, or if the service provider determines that party 103 is not a potential buyer, then the service provider excludes party 103 from contacting seller 102, and excludes party 103 from scheduling an appointment to visit the property. If the service provider successfully completes a screening of party 103 on behalf of seller 102, party 103 is granted access to a scheduler to schedule an appointment and meeting time to visit seller 102's property. If party 103 makes a request to schedule a meeting time with seller 102, then in step 37, the service provider communicates party 103's information to seller 102.

In step 39, party 103 requests notification from the service provider of new or additional listings meeting predetermined buying criteria established by party 103. Such predetermined criteria could be, for example, geographic location, price range, or square footage. The service provider communicates a reply to party 103 using a communication network, for example the Internet, a cell phone network, or a plain old telephone service (POTS) network. Method 100 next progresses to step 40.

In step 40, party 103 receives notification from the service provider of a new or additional listing meeting party 103's predetermined buying criteria. Method 100 next progresses to step 41.

In step 41, party 103 requests a home visit appointment at a time designated by seller 102 in a scheduler, as a viable appointment time. Party 103 can also propose an alternative meeting time not already designated by seller 102. Method 100 next progresses to step 43.

In step 43, seller 102 accepts or rejects a proposed alternative meeting time made by party 103, to visit seller 102's property. After seller 102 and party 103 agree upon a meeting time, then method 100 progresses to step 45.

The service provider provides access to a scheduler to facilitate the scheduling of an appointment for party 103 to visit the property. The scheduler is described below, in the association with FIG. 3. The scheduler shows a time during which the property is available for visiting, enables seller 102 to access the scheduler to specify the time, and enables party 103 to access the scheduler to schedule an appointment to visit the property during the time.

In step 45, party 103 conducts a site visit of seller 102's property. Method 100 next progresses to step 49.

In step 49, party 103 either makes an offer to seller 102, or decides to continue looking for other properties. If party 103 decides to continue looking for other properties, then method 100 branches back to step 33. If party 103 makes an offer that seller 102 finds acceptable, then method 100 progresses to step 61, and may employ one or more of steps 51, 53, 55, 57, and 59.

In steps 51, 53, 55, 57, and 59, additional services are provided by the service provider to seller 102 and/or party 103. In step 51, the service provider provides a referral to a provider of legal services. In step 53, the service provider provides mortgage financing and appraisal services. In step 55, the service provider provides title insurance services. In step 57, the service provider provides other insurance services. In step 59, the service provider provides member services offered by service provider partners.

In step 61, party 103 and seller 102 conclude a sale transaction for seller's 102 property.

FIG. 3 is a block diagram of a system 300 that employs method 100. System 300 includes a processor 315 coupled to a communication network 305 via a data link 310. Communications network 305 can be, for example, the Internet, a cell phone network, or a plain old telephone service (POTS) network. A memory 320 contains a program module 325. Seller 102 and party 103 access processor 315, and in turn program module 325, via communication network 305.

Program module 325 contains instructions that control processor 315 to execute method 100. Program module 325 includes a scheduler 330 with which seller 102 and 103 can schedule an appointment for party 103 to visit the property. In this regard, program module 325 controls processor 315 to (a) present scheduler 330, wherein the scheduler shows a time during which the property is available for visiting, (b) enable seller 102 to access the scheduler via communication network 305, to specify the time, and (c) enable party 103 to access the scheduler via communication network 305, to schedule an appointment to visit the property during the time. Processor 315 sends a communication to seller 102 that indicates that party 103 has scheduled the appointment. Scheduler 330 can be presented, for example, on a display at the location of seller 102, and on a display at the location of party 103.

Program module 325 also controls processor 315 to (a) receive a communication from party 103, indicating a desire of party 103 to schedule the appointment, (b) determine whether party 103 is a potential buyer of the property, and (c) exclude party 103 from scheduling the appointment if the determining concludes that party 103 is not a potential buyer of the property.

Program module 325 also controls processor 315 to request information from party 103, and exclude party 103 from scheduling the appointment if party 103 does not provide the information. Examples of such information include an identification of party 103, contact information for party 103, identification of an employer of party 103, contact information of an employer of party 103, and a combination thereof.

Although program module 325 is shown as residing in memory 320, program module 325 can be tangibly embodied as a computer-readable program on a storage medium 335 for subsequent installation into memory 320. Storage medium 335 can be any conventional storage medium, including, but not limited to, a floppy disk, a compact disk, a magnetic tape, a read only memory, or an optical storage medium. Storage medium 335 could also be a random access memory, or other type of electronic storage, located on a remote storage system and coupled to memory 320.

Moreover, although program module 325 is described herein as being installed in memory 320, and therefore being implemented in software, it could be implemented in any of hardware, firmware, software, or a combination thereof.

Seller 102 can create a six-month calendar of available dates and time when the property is available for visitation by party 103, either during scheduled appointment times or for “open houses” when anyone may visit without an appointment. A home visit scheduler is embedded within seller 102's property listing on the service provider's website, and may be updated by seller 102 at any time. Seller 102 is automatically notified of a scheduled visit via email or telephone and is given party 103's security check information, the security check information being derived from the pre-screening questionnaire completed by party 103 (see step 36).

The pre-screening questionnaire must be completed by party 103 either online or via a national toll-free number. Party 103 obtains the toll-free number from seller 102's lawn sign or via the Internet. The lawn sign will not present a seller 102's personal contact information. Indeed, seller 102 and party 103 do not have any direct contact prior to a home visit unless seller 102 authorizes such contact. The toll-free number connects party 103 to a call center agent who will obtain, or an automated system that will obtain, various contact and security data from party 103 before granting access to the scheduler.

Seller 102 may at any point cancel his membership plans with the service provider, and, if seller 102 agrees to have the property listing transferred to a realtor-partner of the service provider and sign a local listing agreement with a local agent of the realtor-partner, receive a refund of any fees previously paid to the service provider. Such a refund is not contingent upon whether an eventual sale is made.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method performed by a service provider, comprising:
providing a service to a seller for a fee, to assist said seller in a sale of a property without an agent to represent said seller; and
refunding said fee, if said seller lists said property with an agent suggested by said service provider.

2. The method of claim 1, wherein said property comprises real estate.

3. The method of claim 1, wherein said refunding is not contingent on whether said agent suggested by said service provider consummates a sale of said property.

4. The method of claim 2, wherein said service includes providing training material to said seller regarding a sale of real estate.

5. The method of claim 1, wherein said service includes providing a toll-free telephone number that a party can call to inquire about said property.

6. The method of claim 1, wherein said service includes:
receiving a communication from a party, indicating a desire of said party to contact said seller;
determining whether said party is a potential buyer of said property; and
excluding said party from contacting said seller if said determining concludes that said party is not a potential buyer of said property.

7. The method of claim 1, wherein said service includes:
receiving a communication from a party, indicating a desire of said party to schedule an appointment to visit said property;
requesting information from said party; and
excluding said party from scheduling said appointment if said party does not provide said information.

8. The method of claim 7, wherein said information is selected from the group consisting of identification of said party, contact information for said party, identification of an employer of said party, contact information of an employer of said party, and a combination thereof.

9. The method of claim 1,
wherein said service includes providing a system that shows a time during which said property is available for visiting, and
wherein said system:
enables said seller to access said system to specify said time; and
enables a party to access said system to schedule an appointment to visit said property during said time.

10. The method of claim 9, wherein said system sends a communication to said seller that indicates that said party has scheduled said appointment.
